(19) United States
(12) Patent Application Publication
(10) Pub. No.: US 2006/0168528 A1
(43) Pub. Date: Jul. 27, 2006

(54) Method for arranging user interface glyphs on displays

(75) Inventor: Robert W. Gruen, Charlotte, NC (US)

Correspondence Address: VIERRA MAGEN/MICROSOFT CORPORATION, 575 MARKET STREET, SUITE 2500, SAN FRANCISCO, CA, 94105, US

(73) Assignee: Microsoft Corporation, Redmond, WA (US)

(21) Appl. No.: 11/044,321

(22) Filed: Jan. 27, 2005

(51) Int. Cl. G06F 9/00

(52) U.S. Cl. 715/744; 715/746; 715/747; 715/765; 715/866

(57) ABSTRACT

The present invention provides a graphical user interface where a pointing device can move desktop objects accurately and across large distances on a display. A screen map is created on the desktop in which is displayed a bitmap of the desktop. Objects in the screen map can be moved within the screen map to affect large movements of objects on the desktop.

### BACKGROUND OF THE INVENTION

1. Field of the Invention

The present invention is directed to methods for arranging user interface glyphs on electronic displays.

2. Description of the Related Art

A computer desktop display is a metaphorical representation of a real desktop where commonly used objects may be stored for ready access. In the electronic context, a desktop provides a graphical user interface where a user can select graphical representations, or icons, for quick access to such objects as often used files, pictures, software applications, etc. For example, FIG. 1 shows a conventional desktop 10 including icons 12 for quick access to a directory of a computer's contents, access to the Internet, access to an often used folder and a virtual receptacle for objects that are no longer needed. Other desktop icons are well known. Desktop 10 may further include one or more windows, such as windows 14 and 16, which are viewing areas on the display which may be open, shut and sized as desired, and which provide access to various software applications running concurrently by the computer's operating system. In FIG. 1, window 14 shows and provides access to a page on the World Wide Web via a web browser, and window 16 shows and provides access to files within a folder on the host computer. A typical Windows® operating system desktop may further include a status bar 18, including various icons such as for example a start menu icon 20, one or more customized quick launch icons 22 for quickly opening select objects, open program shortcuts 24 showing the open windows on the desktop, system icons 26 for managing system components and the time 28.

Typically, a user interfaces with the desktop via a keyboard and a pointing device, which controls the movement of a cursor around the desktop to open, close and otherwise manage the desktop icons and windows. Pointing devices have traditionally been effective and efficient in navigating smaller and average size display screens. However, as display screens have gotten larger and larger, and with the rise in popularity of multi-monitor displays, it has become commonplace for monitors to have displays of over 10K by 5K pixels. Conventional pointing devices are not always effective in navigating displays of these sizes.

In particular, a single mouse stroke will generally not complete a sweep of the cursor across a large display, and it becomes necessary to pick up and reposition the mouse to complete the cursor movement. In addition to the inconvenience, this repeated action enhances the possibility of wrist or other joint disorders. While most mouse drivers provide the ability to set the mouse to a higher speed or acceleration, for large displays, this can lead to a situation where the mouse speed exceeds the refresh rate of the monitor, causing the mouse to appear to jump across the screen. This jumping, together with the large change in distance for a small mouse movement, makes it difficult to control accelerated mouse settings, and pointing accuracy is largely lost. There is therefore a need in the prior art for a graphical user interface where a mouse pointing device can accurately span the large distances provided by large and multiple display screens.

Virtual desktop management is known where a number of desktops may be viewed simultaneously on a single computer display. However, virtual desktop management is directed to moving folders and icons from one virtual desktop to another by dragging and dropping with the mouse. Such systems do not address the problem of accurately spanning the distances across large display screens.

### SUMMARY OF THE INVENTION

The present invention provides a graphical user interface where a pointing device can move desktop objects accurately and across large distances on a display. A window, referred to herein as a screen map, is created on the desktop in which is displayed a bitmap of the desktop. The screen map is refreshed at a high rate so that as objects on the desktop are closed, moved and/or resized, the bitmap displayed in the screen map remains an accurate depiction of the contents of the desktop. The screen map may also be sized as desired by the user.

When a screen map object is selected, the screen map coordinates are translated into the corresponding coordinates on the desktop, and the object located at those coordinates on the desktop is identified. Transient images of the object are then displayed in the screen map and on the desktop. Movement of the transient image in the screen map via the pointing device produces a corresponding and proportional movement of the transient object on the desktop. When the transient screen map object is repositioned as desired in the screen map, the transient screen map image is released by the pointing device, and the object on the desktop is displayed at the new position.

Thus, a screen map having a relatively small size in comparison to a large desktop display can affect large movements of objects on the desktop with only small movements of the corresponding objects within the screen map. The multiplier for the x, y movement of an object on the desktop can be selected as desired by a user by selecting the appropriate aspect ratio for the screen map.

### BRIEF DESCRIPTION OF THE DRAWINGS

FIG. 1 illustrates a conventional desktop.

FIG. 2 depicts a block diagram of computer hardware suitable for implementing embodiments of the invention.

FIG. 3 is a flowchart showing the launch and initial steps of the application for performing the present invention.

FIG. 4 illustrates a graphical user interface of a desktop including a screen map provided according to embodiments of the present invention.

FIG. 5 is a flowchart showing the steps of sensing the occurrence and location of a mouse click on the desktop in the application for performing the present invention.

FIG. 6 illustrates a graphical user interface of a desktop including a screen map provided according to embodiments of the present invention having an object from the desktop and screen map removed.

FIG. 7 illustrates a graphical user interface of a desktop including a screen map provided according to embodiments of the present invention having a screen map with a varied aspect ratio as compared to the desktop.

FIG. 8 illustrates a graphical user interface of a desktop showing a mouse click within the screen map and the corresponding coordinates on the desktop.

FIG. 9 is a flowchart showing the steps for a sensed mouse click on the desktop in the application for performing the present invention.

FIG. 10 is a flowchart showing the steps for moving objects on the screen map and desktop.

FIGS. 11A-11C illustrate a graphical user interface of a desktop including a screen map provided according to embodiments of the present invention with an object in the screen map and the corresponding object on the desktop being moved.

FIG. 11D illustrates a graphical user interface of a desktop including a screen map provided according to embodiments of the present invention showing a repositioned object within the screen map and the corresponding repositioned object on the desktop.

FIG. 12 illustrates a graphical user interface of a desktop and the aspect ratios of the screen map to the desktop.

FIG. 13 is a flowchart showing the steps for a sensed right-click of a mouse on an object in the screen map in the application for performing the present invention.

FIG. 14 is a flowchart showing the steps for a sensed right-click of a mouse on wallpaper in the screen map in the application for performing the present invention.

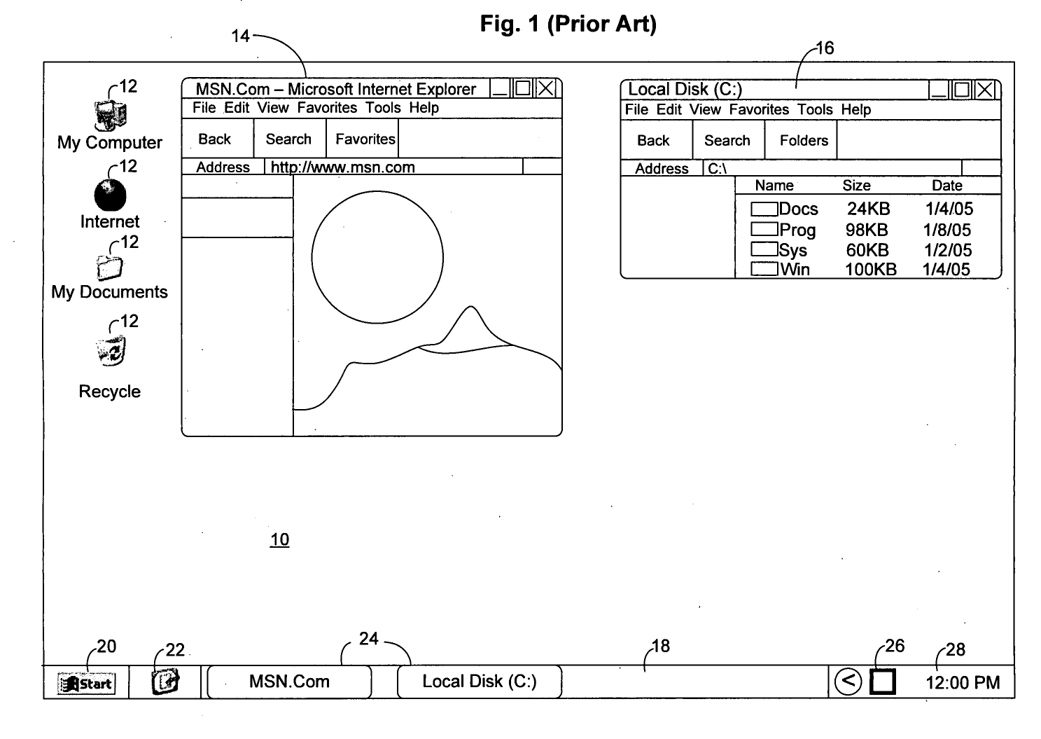

### DETAILED DESCRIPTION

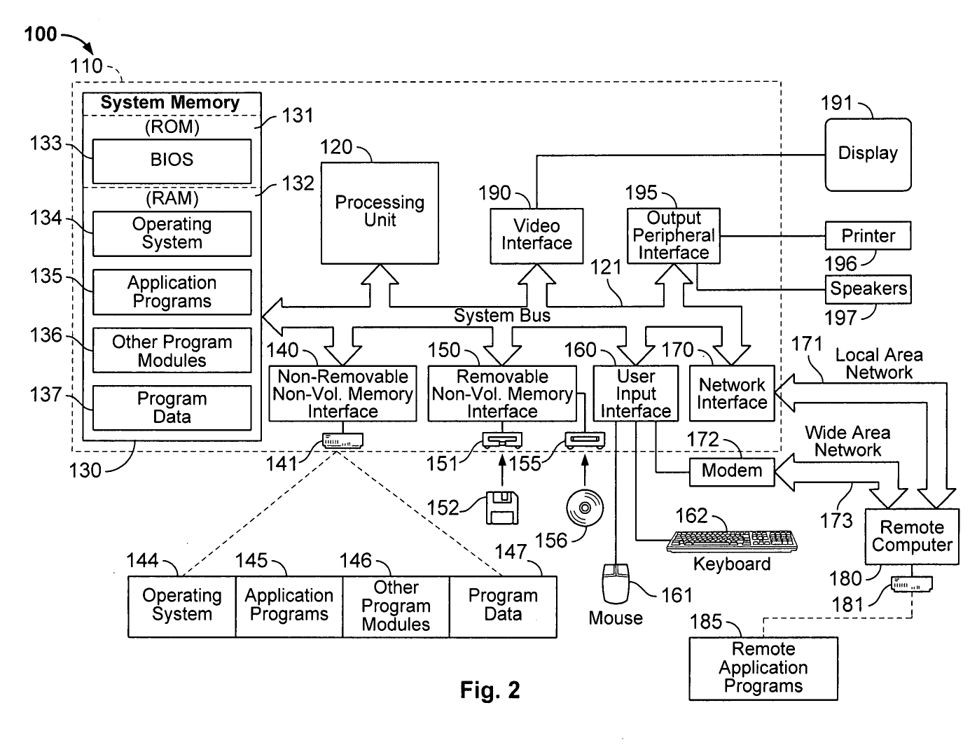

Embodiments of the invention will now be described with reference to FIGS. 2-14, which in general relate to methods for arranging user interface glyphs on displays. The methods described herein can be performed on a variety of processing systems. FIG. 2 illustrates an example of a suitable general computing system environment 100 on which the invention may be implemented. The computing system environment 100 is only one example of a suitable computing environment and is not intended to suggest any limitation as to the scope of use or functionality of the invention. Neither should the computing system environment 100 be interpreted as having any dependency or requirement relating to any one or combination of components illustrated in the exemplary computing system environment 100.

The invention is operational with numerous other general purpose or special purpose computing system environments or configurations. Examples of well known computing systems, environments and/or configurations that may be suitable for use with the invention include, but are not limited to, personal computers, server computers, multiprocessor systems, microprocessor-based systems, set top boxes, programmable consumer electronics, network PCs, minicomputers, mainframe computers, laptop and palm computers, hand held devices, distributed computing environments that include any of the above systems or devices, and the like.

The invention may be described in the general context of computer-executable instructions, such as program modules, being executed by a computer. Generally, program modules include routines, programs, objects, components, data structures, etc., that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 2, an exemplary system for implementing the invention includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above are also included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 2 illustrates operating system 134, application programs 135, other program modules 136, and program data 137.

The computer 110 may also include other removable/non-removable, volatile/nonvolatile computer storage media. By way of example only, FIG. 2 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 2, provide storage of computer readable instructions, data structures, program modules and other data for the computer 110. In FIG. 2, for example, hard disk drive 141 is illustrated as storing operating system 144, application programs 145, other program modules 146, and program data 147. These components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 110 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 190.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 2. The logical connections depicted in FIG. 2 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 2 illustrates remote application programs 185 as residing on memory device 181. It will be appreciated that the network connections shown are exemplary and other means of establishing a communications link between the computers may be used.

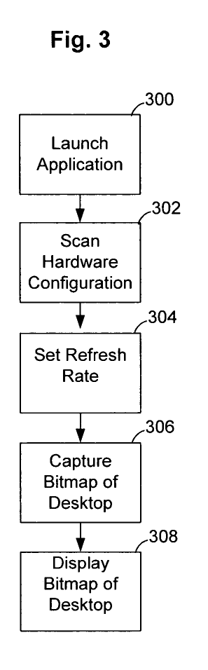

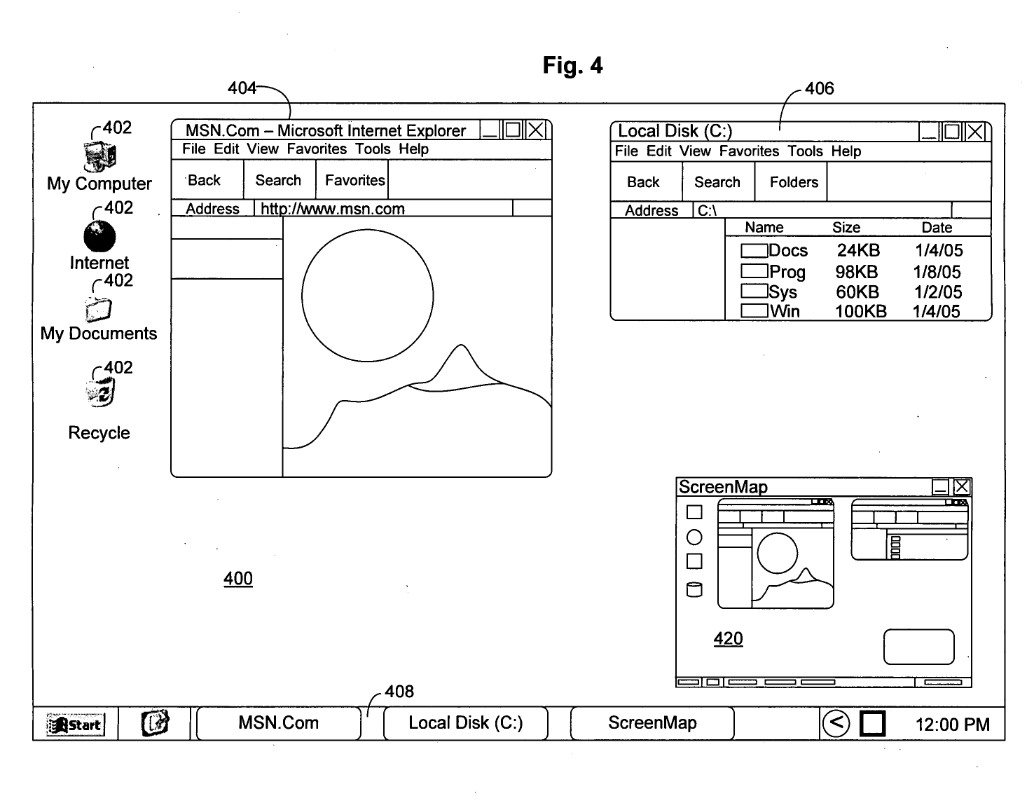

The present invention will now be described with reference to the flowchart of FIG. 3 and the illustration of a graphical user interface of FIG. 4. FIG. 4 shows a desktop 400 including a plurality of icons 402, two windows 404 and 406, and a status bar 408. The desktop 400 may include less icons and windows than shown in FIG. 4, and may include any number of additional and/or other icons, windows and other objects known to exist on a desktop. The desktop shown is that used by the Windows® operating system from Microsoft Corporation, but the present invention may operate with desktops of a variety of other operating systems, such as for example the Linux desktop from Sun Microsystems, Inc. or the Mac desktop by Apple Computer, Inc. Embodiments of the invention are described hereinafter with reference to methods for moving objects around on a desktop. However, it is understood that the present invention may be used to move objects around on any screen display in alternative embodiments.

An application performing the present invention may be launched in step 300, FIG. 3, from a desktop icon or any other known method of executing program modules stored on a computer 110. Upon execution, the application may scan the computer 110 to determine the refresh rate of the display system (step 302). It may then set the refresh rate to be used for refreshing a screen map, explained hereinafter, to some preset time interval slower than the approximate time it takes to create a bitmap of the screen display (step 304). In embodiments, the refresh rate may be every one-third second to one second. It is understood that the refresh rate may be quicker than once every one-third second and slower than once a second, and may also refresh at a rate which is faster than the approximate time it takes to create a bitmap of the screen display, in alternative embodiments. The refresh rate may alternatively be instantaneous or near instantaneous.

In a step 306, the application calls a standard application program interface (API) in the Windows® operating system (e.g., the PrintWindow API) to generate a bitmap of the desktop at the time the application is launched. In a step 308, the bitmap of the desktop is displayed in a window on the desktop, referred to herein as a screen map, as shown at 420 on FIG. 4. The screen map 420 may initially appear in a predetermined size and location on the desktop, and thereafter be resized, moved and manipulated as explained below. As would be appreciated, the bitmap presented within the screen map 420 includes all of the icons, windows, background and other graphical images that appear on the desktop 400, including an image of the screen map 420 itself, although not necessarily at the same resolution as the corresponding objects appearing on the desktop. APIs in operating systems other than the Windows® operating system are known for capturing a screen image and displaying the captured image in a window. It is also understood that program steps other than APIs may be used to obtain the bitmap.

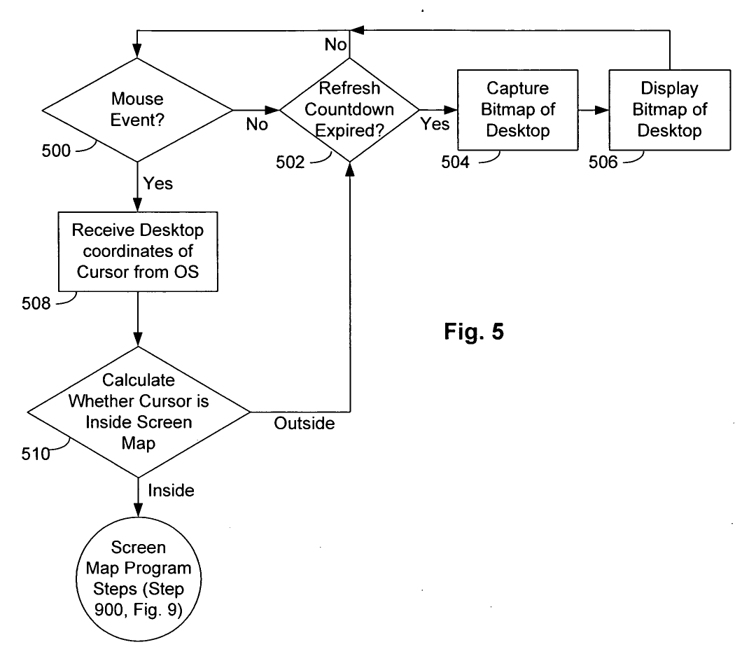

The application performing the present invention allows a user to move objects around large distances on the desktop through manipulation of the corresponding object within the screen map 420. In particular, each of the objects, alternatively referred to herein as glyphs, within the screen map 420 may be selected and dragged to a different position within the screen map 420. This movement of the object within the screen map results in the proportional and larger movement of the corresponding object on the desktop. Referring to the flowchart of FIG. 5, after the initial steps 300-308, the application looks for notification from the operating system of a mouse event in step 500. The event may be a “button down” (i.e., pressing and holding down a mouse button), and may also be a mouse click or double click in further embodiments. In the event no mouse event is detected, the application checks the refresh rate countdown (step 502), and returns to step 500 if the countdown has not expired. If the refresh rate countdown has expired, a bitmap of the desktop is captured (step 504) and displayed in screen map 420 on the desktop (step 506).

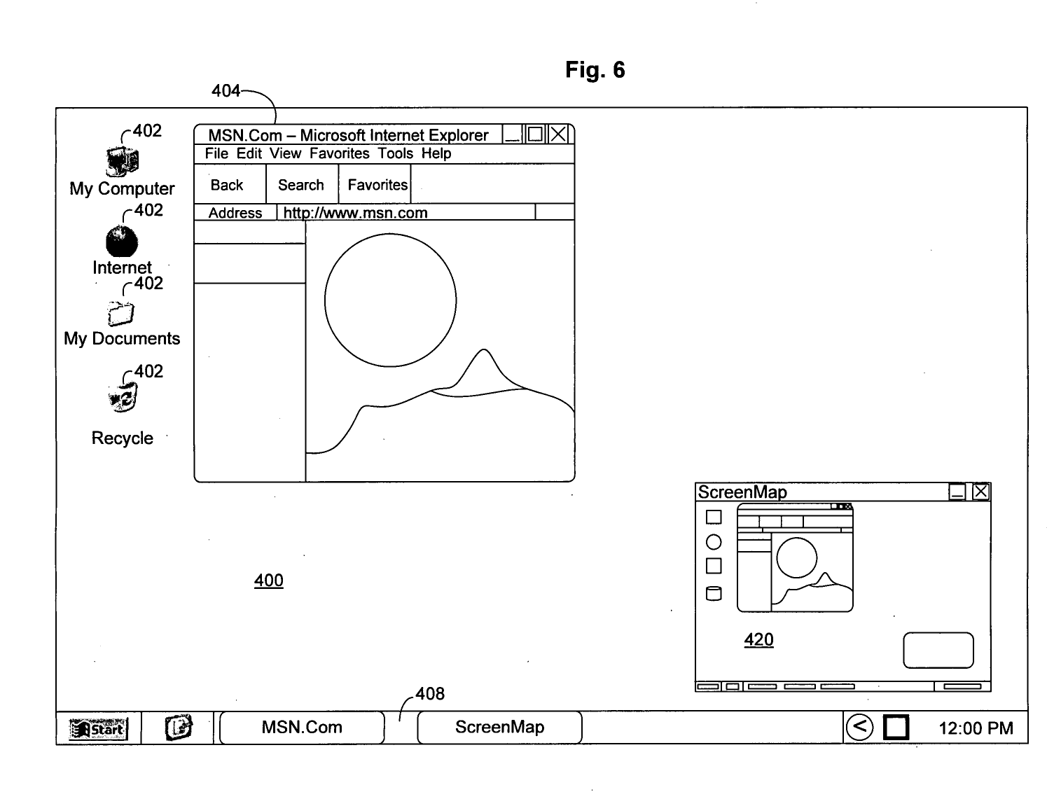

As indicated in steps 502-506, the application performing the present invention cyclically refreshes the screen map 420 at the refresh rate determined in step 304, using the standard screen capture API to generate a new bitmap of the current display on the desktop and then displaying the bitmap in the screen map 420. Thus, as objects are added to, taken off and/or resized on the desktop 400, the corresponding objects appear on, disappear from and/or resize on the screen map 420. As shown for example in FIG. 6, if a window is closed, such as window 406, the refreshed bitmap shown in the screen map 420 will similarly omit the window 406.

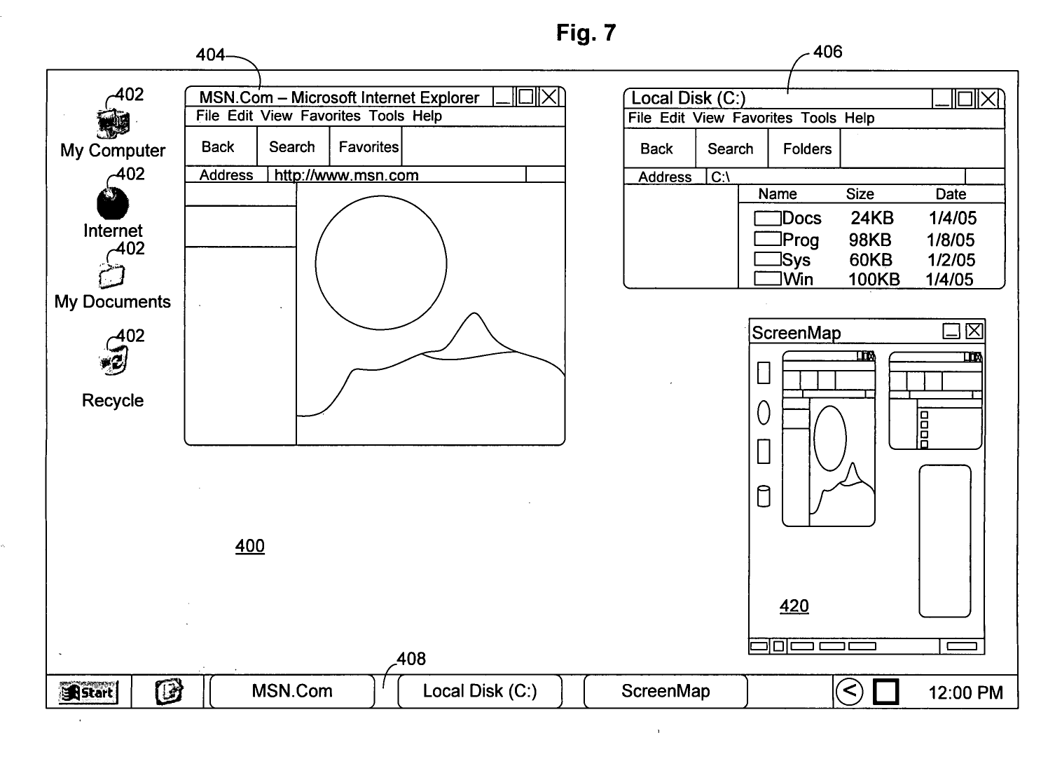

The screen map 420 window may have operative characteristics similar to that of other conventional desktop windows. For example, the screen map may be selected (as by clicking a mouse key with the cursor positioned on the screen map) and dragged about the desktop, it may be minimized to the task bar 408, it may be resized, both with the same aspect ratio or different aspect ratio, it may be closed, it may be brought to the foreground or background and, once altered, it may be restored to its previous dimensions. In embodiments of the invention, the screen map 420 shows all of the objects that appear on the desktop 400. Thus, when the aspect ratio of the screen map 420 is changed, as shown for example in FIG. 7, instead of cutting off objects outside of the dimensions of the window, the aspect ratio of the objects within the screen map change by the same aspect ratio. Thus, all objects on the desktop remain visible within screen map 420, albeit with a different aspect ratio than the corresponding objects on the desktop 400. In alternative embodiments, it is understood that the aspect ratio of the objects within the screen map may not change when the aspect ratio of the screen map is changed.

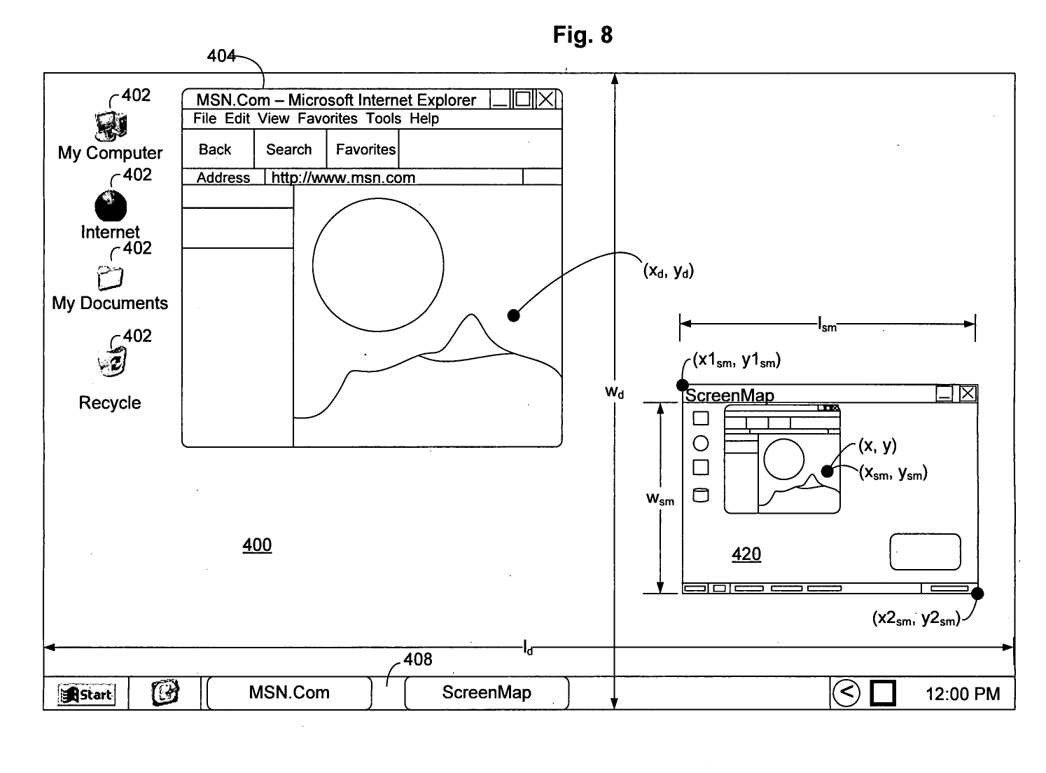

Referring again to FIG. 5, in the event the operating system detects a mouse event on the display in step 500, the coordinates of the mouse event are received from the operating system (step 508). The application next determines whether the event occurred at coordinates that are inside or outside the screen map 420 (step 510). A method used in embodiments of the invention for making this determination is explained with reference to FIG. 8. The application receives the position of the screen map on the display from the operating system. The screen map position may have a first corner, for example the upper left corner, on the display at coordinates (x1ₛₘ, y1ₛₘ) and a diagonally opposed corner, for example the lower right corner, on the display at (x2ₛₘ, y2ₛₘ). The coordinates of the cursor position identified by the operating system when the mouse event is received are (x, y). The application determines that the coordinates (x, y) are inside the screen map if the coordinates (x, y) satisfy the conditions:
x1ₛₘ≦x≦x2ₛₘ, and
y1ₛₘ≦y≦y2ₛₘ.
Otherwise, the coordinates (x, y) are not inside the screen map.

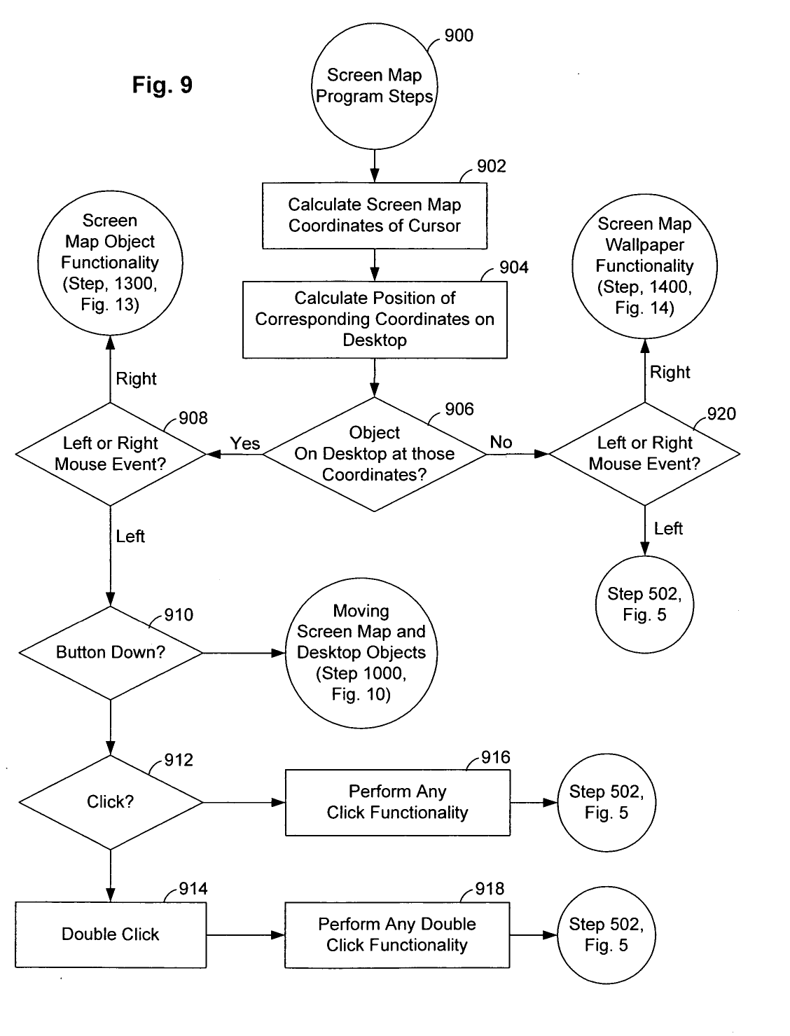

Referring again to step 510, FIG. 5, if the event occurred while the cursor is outside of the screen map, any desired operation initiated by the mouse event is handled by the operating system in accordance with normal desktop functionality, and the application returns to step 502. If it is alternatively determined that the mouse event occurred within the screen map in step 510, the application then performs the screen map program steps discussed with respect to FIG. 9. Some operating systems, such as the Windows® operating system, are capable of determining automatically (using the same logic as set forth above) whether a mouse event such as a mouse click occurred when the cursor is inside a window such as the screen map. For these operating systems, embodiments of the application for performing the present invention may receive notification from the operating system only when the mouse event occurred while the cursor is within the screen map. In such embodiments, steps 508 and 510 may be omitted, and the application may proceed directly to the steps discussed with respect to FIG. 9 upon receiving the notification from the operating system of an event while the cursor is within the screen map.

As shown in FIG. 9, upon the determination of a mouse event within the screen map 420, the application next calculates the coordinates of the cursor from the frame of reference of the screen map (step 902) to yield the screen map coordinates (xₛₘ, yₛₘ) of the cursor. In particular, referring again to FIG. 8, the screen map coordinates (xₛₘ, yₛₘ) are given by:

xₛₘ=x−x1ₛₘ, where x is the x coordinate on the display of the cursor, and

yₛₘ=y−y1ₛₘ, where y is the y coordinate on the display of the cursor.

Once the screen map coordinates are determined, the position of the desktop coordinates corresponding to the screen map coordinates are calculated in step 904. A method used in embodiments of the invention for making this calculation is explained with reference again to FIG. 8. The desktop coordinates (x_{d}, y_{d}) are given by:

X_{d}=(xₛₘ)(I_{d}/Iₛₘ), where I_{d} is the length of the desktop and Iₛₘ is the length of the screen map. Similarly:

y_{d}=(yₛₘ)(w_{d}/wₛₘ), where w_{d} is the width of the desktop and wₛₘ is the width of the screen map.

Once the desktop coordinates are calculated in step 904, the application determines whether the desktop coordinates (x_{d}, y_{d}) coincide with the location of an object on the desktop display (step 906). The location of each of the objects on the desktop display is stored in memory and is available to the operating system. If the desktop coordinates coincide with the location of an object on the desktop in step 906, the mouse event occurred while the cursor is located on an object within the screen map and the application then checks to see what operation the user would like to perform on the corresponding desktop object.

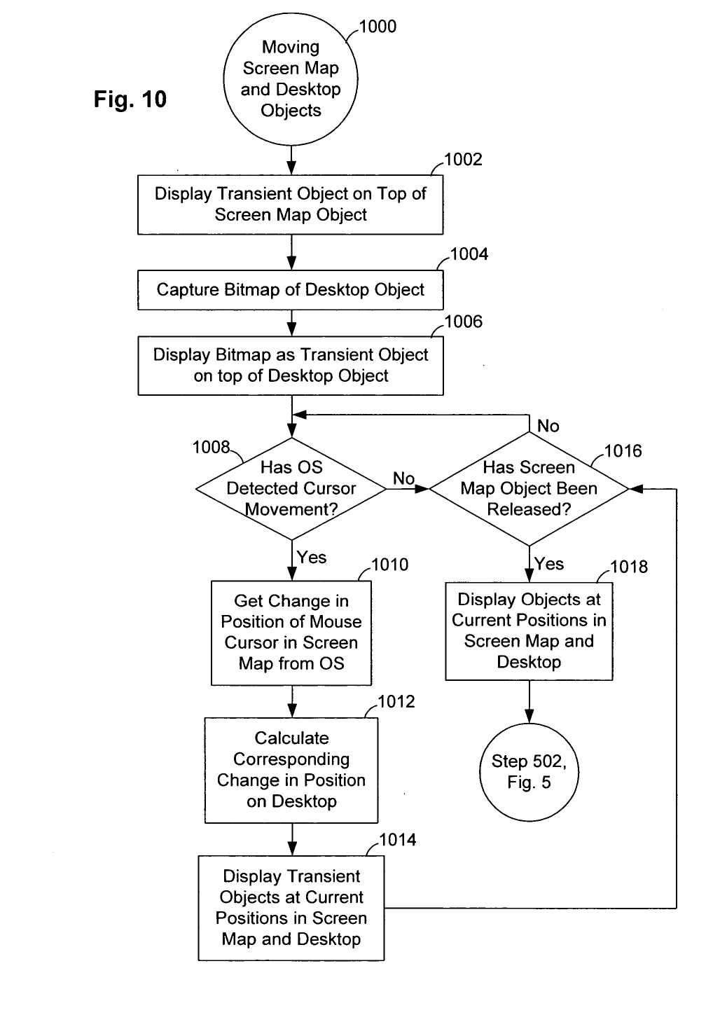

In a step 908, a check is made whether the mouse event was a left mouse button event or a right mouse button event, as left and right events initiate different operations. With respect to a left button event, the application receives the type of event from the operating system. If the operating system communicates a button down event in step 910, the application performs a “click and drag” operation normally associated with the left button down and movement of a mouse on a desktop object, as explained in greater detail below with reference to FIG. 10.

In embodiments of the invention, the application may further receive from the operating system whether the mouse event is a click (step 912) or a double click (step 914). In the event a click is detected, the application performs the functionality in step 916 that a mouse click would initiate, if any, if the cursor was located on the desktop position corresponding to the current position of the cursor in the screen map. For example, if the cursor were located on a quick launch icon in the screen map, the click could cause the corresponding application on the quick launch menu on the desktop to run. The application then returns to step 502 shown in FIG. 5. In the event a double click is detected, the application performs the functionality in step 918 that a double mouse click would initiate, if any, if the cursor was located on the desktop position corresponding to the current position of the cursor in the screen map. For example, if the cursor were located on an icon in the screen map, the double click could cause the corresponding application on the desktop to run. The application then returns to step 502 shown in FIG. 5.

It is understood that embodiments of the invention may only detect a button down event. In such embodiments, if a left button down is detected in step 908, the application may proceed directly to the click and drag operations described with respect to FIG. 10 below, and steps 912 through 918 may be omitted. Clicks and Double clicks would simply be treated as click and drag operations comprising a mouse down/mouse up event without movement of the cursor.

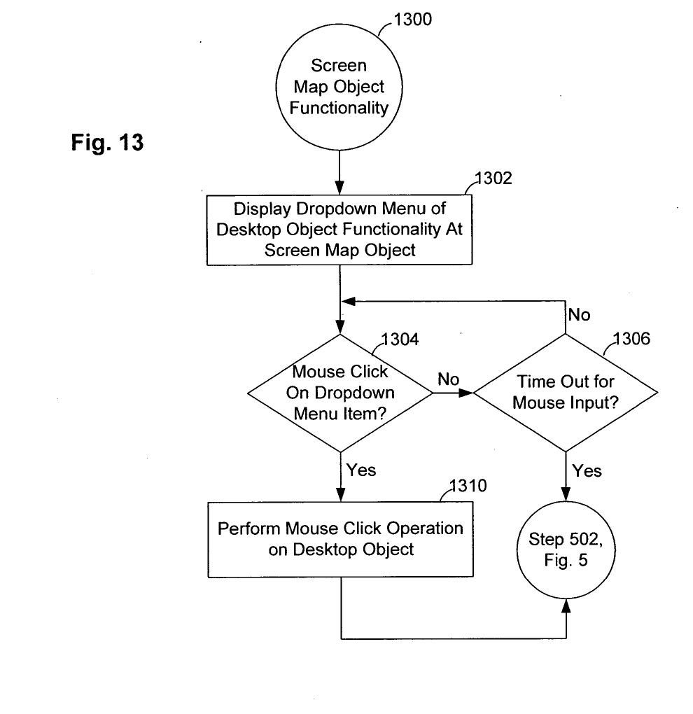

If, in step 908, a right button event was received (button down, click or double click), the application performs one or more operations normally associated with a right click of a mouse on a desktop object as explained in greater detail below with reference to FIG. 13.

The specific operations described herein upon left and right button events while the cursor is in the screen map may be those operations that are traditionally available and performed upon left and right button events with the cursor in the corresponding position on the display. It is understood that a mouse may be programmed to reverse or otherwise alter the functionality of the left and right mouse buttons. It is also possible that users can configure multiple button mice/pointing devices to have each button be a specific function.

Moreover, user interface selection device 161 has been described above as a mouse, but may be any known pointing device including a mouse, track ball, touch pad, stylus, etc. While reference is often made above and below to a mouse event or click as indicating actuation of a button on a mouse, it is understood that the term refers in general to any of various interface selection device events that take place upon actuation of any of various interface selection devices. For example, on pointing devices such as a pen-type pointing device, there are no left or right buttons, but instead some other interaction is provided that indicates the traditional left button and right button functionality. It is further contemplated that embodiments of the present invention operate with large touch screen displays. The application performing the present invention may work equally well with such configurations. For such embodiments, the user interface selection device may be a stylus or a finger on the display for selecting and dragging an object within the screen map. Regardless of the interface selection device, the operating system is typically able to determine the functionality of an interface selection device event (i.e., actuating a button on the pointing device) from the interface selection device drivers.

It is therefore understood that, despite the reference above and hereinafter to the specific functionality provided in embodiments upon a left button and right button events, the invention more broadly may provide other functionality upon an interface selection device event in alternative embodiments. As one example, where a mouse has been configured to reverse the functionality of the left and right buttons, traditional right click functionality may be provided in embodiments where the left button is depressed with the cursor on an object in the screen map. More generally, the operating system identifies what and where the interface selection device event is on the screen map and provides this information to the application performing the present invention. The application then determines the corresponding position on the desktop, and the application provides the functionality corresponding to that interface selection device event in the screen map as if the cursor were on the corresponding position on the desktop when the interface selection device event took place.

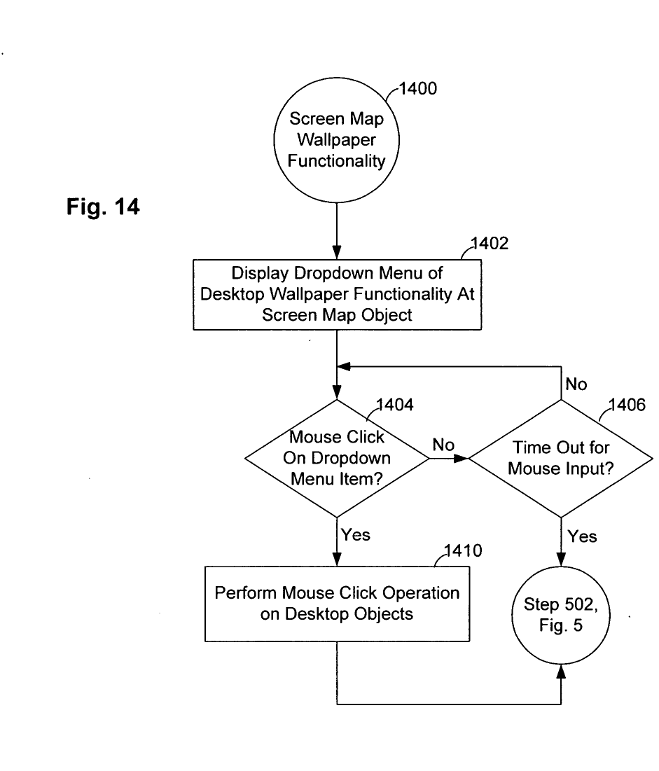

If, in step 906, it is instead determined that the desktop coordinates (x_{d}, y_{d}) do not coincide with an object on the desktop, then the user has performed a mouse event while the cursor was positioned in the screen map on a space between objects (i.e., on the background wallpaper). In this instance, the application again checks for a left or right event in step 920, as left or right mouse events on desktop wallpaper initiate different operations. If a left event is received (button down, click or double click), no operation is performed on desktop objects and the application returns to step 502, FIG. 5. If a right event is received (button down, click or double click), the application performs one or more operations normally associated with a right click of a mouse on desktop wallpaper as explained in greater detail below with reference to FIG. 14.

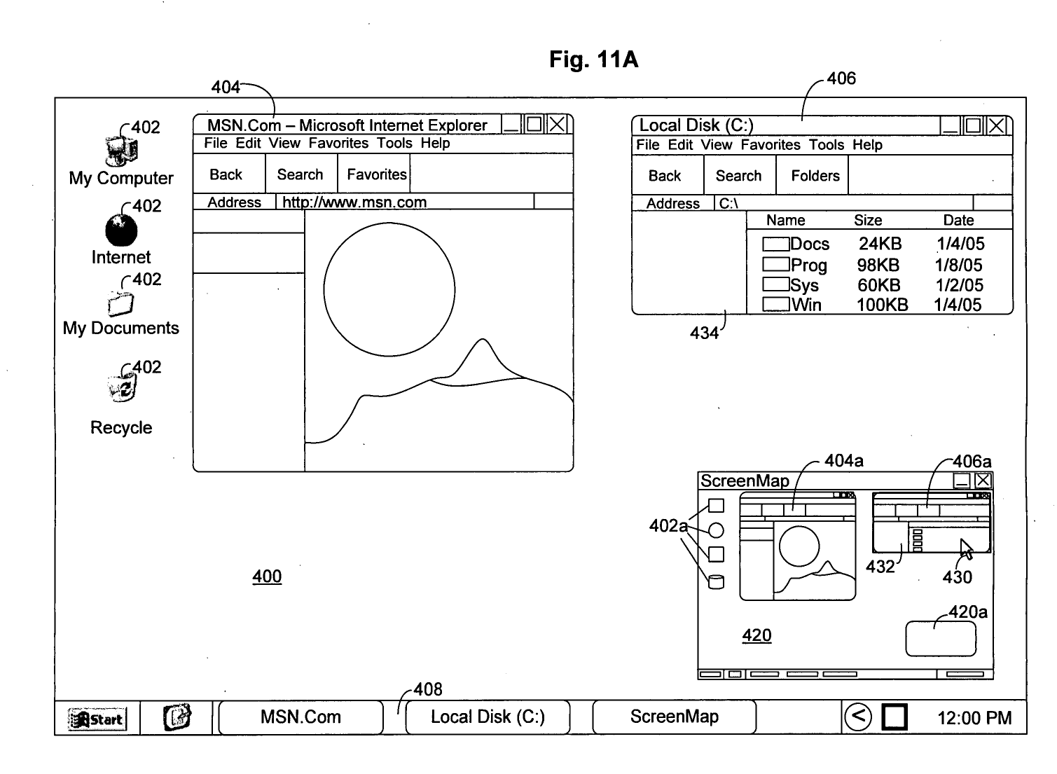

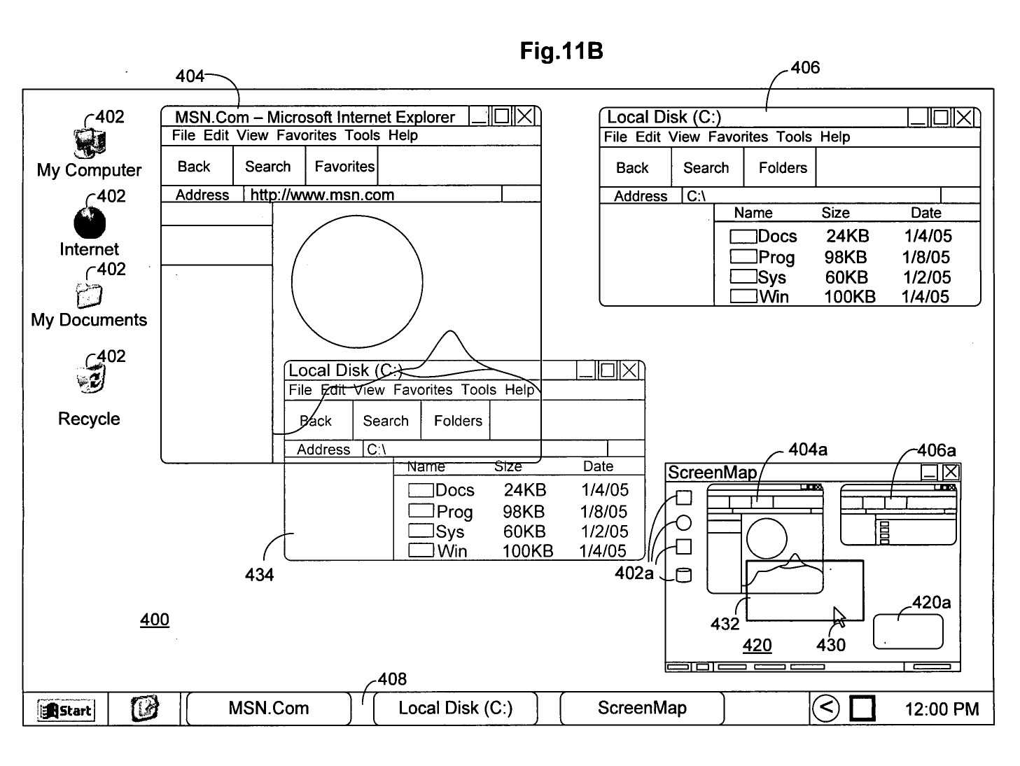

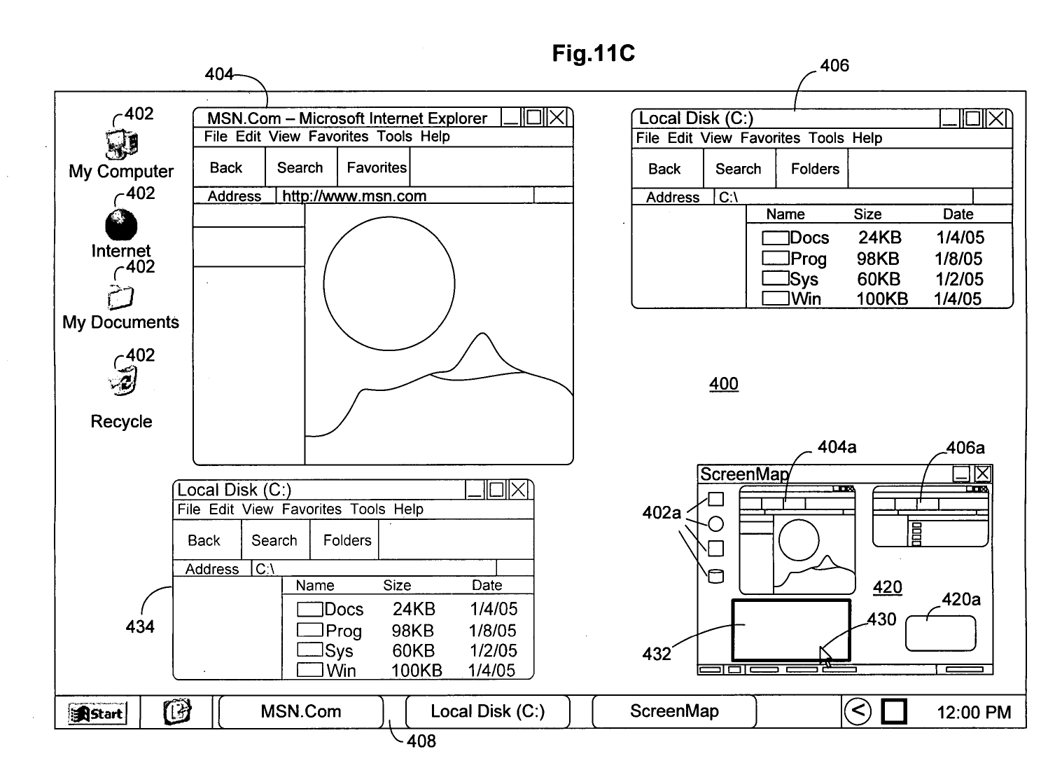

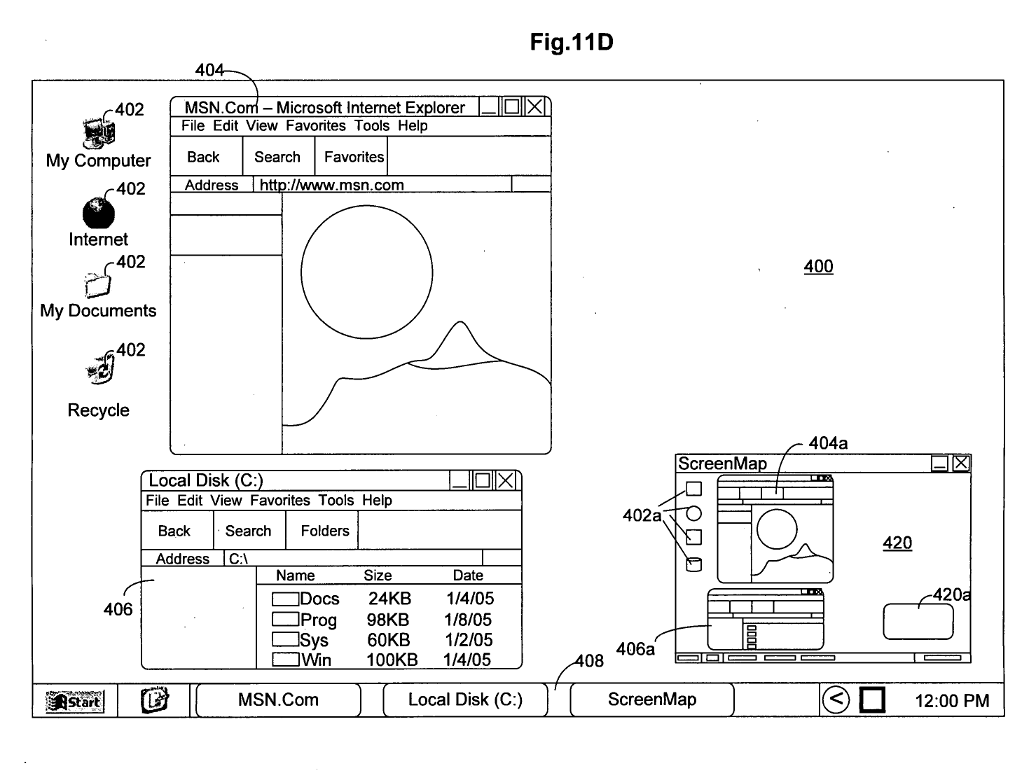

Movement of objects will now be explained with reference to the flowchart of FIG. 10 and the graphical user interfaces shown in FIGS. 11A-11D. FIGS. 11A-11D show the screen map 420 with each of the objects therein numbered with a reference numeral that relates to its corresponding reference numeral on the desktop (e.g., window 404 on the desktop 400 corresponds to object 404a within the screen map 420).

FIGS. 11A-11D also show a pointer 430 on the display which is controlled by user interface selection device 161 (FIG. 2) in a known manner. Pointer 430 is shown in FIG. 11A selecting an object 406a; that is, with the pointer 430 positioned over the object 406a, a button or other indicator on the pointing device 161 and/or keyboard 162 is actuated to allow selection and dragging of the selected object to a new position by movement of the pointing device. This ability to select by mouse click or keyboard stroke, and subsequently to drag by pointing device movement, is well known and standard functionality within Windows® operating systems. Once an object is selected, refresh of the desktop bitmap in screen map 420, described above with respect to step 502-506, FIG. 5, is stopped until the object is released as described hereinafter.

Referring now to FIG. 10, once an object, such as object 106a, on the screen map is selected with a left button down event, the application displays a transient screen map object on top of the selected screen map object in a step 1002. The transient screen map object, shown at 432 in FIGS. 11A-11D, may be a rectangle having the same general footprint (i.e., same length and width) of the screen map object over which it is displayed. The application also captures a bitmap of the corresponding desktop object (in this instance, window 406) in step 1004, and displays the captured bitmap as a transient desktop object on top of the desktop object in a step 1006. The transient desktop object, shown at 434 in FIGS. 11A-11D, may be a copy of the object on the desktop over which it is displayed. Although it is indistinguishable at this point from the object over which it is displayed, the transient desktop image 434 may be displayed with a degree of transparency so that portions of objects behind the transient desktop object 434 are visible through the transient object 434.

Standard Windows®) operating system APIs are known for capturing a bitmap of a selected object, such as the PrintWindow API, and displaying that captured object with any desired degree of transparency. APIs in other operating systems having this functionality are also standard.

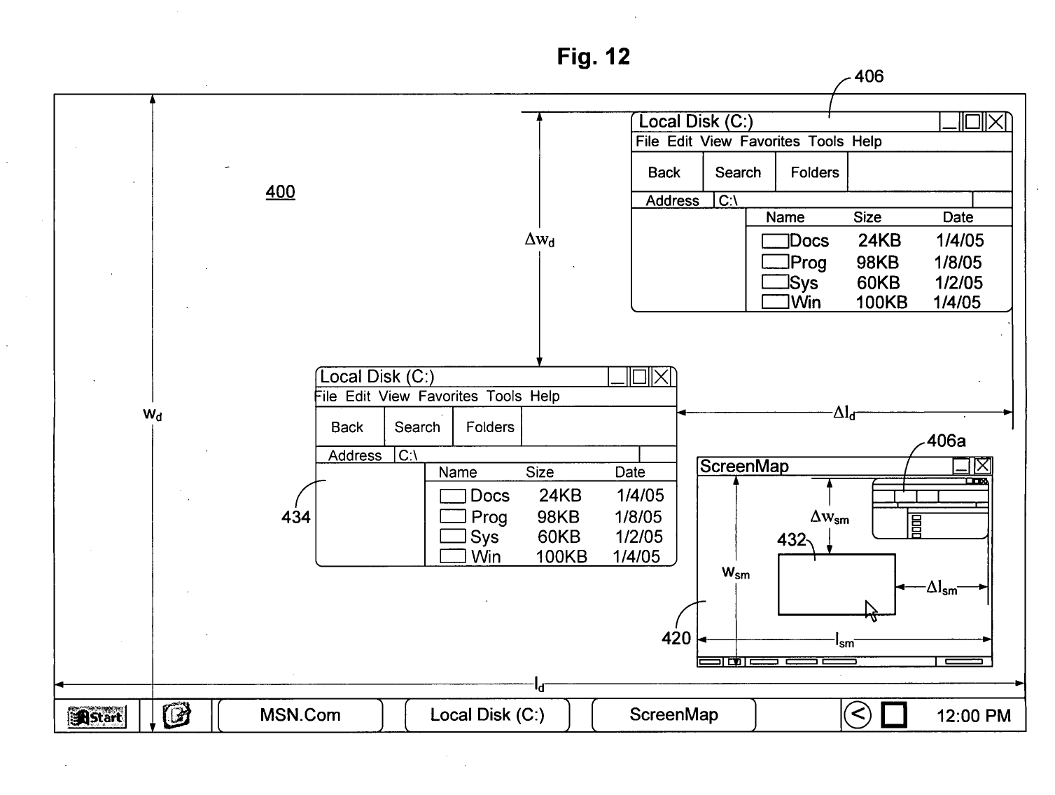

In a step 1008, the application checks whether the operating system has detected movement of the mouse. If so, the change in position of the mouse cursor is obtained from the operating system in step 1010. From this the corresponding and proportional change in position on the desktop is calculated. A method used in embodiments of the invention for calculating this proportional movement is explained with reference to FIGS. 11B and 12. FIG. 12 shows the same relation of the objects on the desktop 400 and screen map 420 as is shown in FIG. 11B. Some of the objects of FIG. 11B have been omitted from FIG. 12 for clarity. FIG. 12 shows that desktop 400 has a length of Id pixels and a width of w_{d} pixels, and that the screen map has a length of Iₛₘ pixels and a width of wₛₘ pixels. Under the control of pointing device 161, the object 406a has been moved in the screen map 420 in FIGS. 11B and 12 from its original position ΔIₛₘ pixels to the left, and Δwₛₘ pixels down. For such movement of the object 406a in the screen map 420, the window 406 undergoes a change in position, ΔI_{d} and Δw_{d}, on the desktop given by:
ΔI_{d}=(ΔIₛₘ)(I_{d}/Iₛₘ), and
Δw_{d}=(Δwₛₘ)(w_{d}/wₛₘ).
Thus, it can be seen that a screen map 420 having a relatively small size in comparison to the desktop can effect large movements of objects on the desktop with only small movements of the corresponding objects within the screen map. The multiplier for the x, y movement of an object on the desktop can be selected as desired by a user by selecting the appropriate x, y dimensions for the screen map 420.

Once the corresponding change in position on the desktop is calculated in step 1012, the new positions of the transient screen map object 432 and transient desktop object 434 are displayed (step 1014) as shown in FIG. 11B, and the application next checks if the screen map object has been released by the pointing device in step 1016 as explained hereinafter.

Upon display and movement of the transient screen map object, the original, starting position of the screen map object may remain visible as shown in FIG. 11B until the object is released at a new position as explained hereinafter. FIG. 11B shows the original, starting position of the screen map object as a solid image, and the moving transient screen map object 432 in the form of a rectangular box having the footprint of the object being moved. It will be appreciated that other options for displaying the screen map object in its original, starting position and in its transient form are possible in alternative embodiments. The original, starting position of the screen map object may be shown only as an outline or footprint of the object. The original starting position of the screen map object may be shown transparently. Or the original starting position of the screen map object may not be shown in the screen map at all (i.e., once the object is moved, its original, starting position is no longer shown).

Similarly, instead of a rectangular footprint, the transient screen map object may be displayed as a bitmap image, transparently, in solid view (i.e., portions of objects behind the moving object are not visible) or as just an outline of the screen map object. Similarly, the display may show a trail of echo images along the path of the transient screen map object as the transient screen map object is moved.

Upon display and movement of the transient desktop object, the original, starting position of the desktop object may also remain visible until the screen map object is released (mouse button up) at a new position as explained hereinafter. FIG. 11B shows the original, starting position of the desktop object as a solid image, and the moving transient desktop object 434 in the form of a transparent bitmap image of the object being moved. However, it will be appreciated that other options for displaying the desktop object in its original, starting position and in its transient form on the desktop are possible. The original, starting position of the desktop object may be shown only as an outline or footprint of the desktop object. The original starting position of the desktop object may be shown transparently. Or the original starting position of the object may not be shown on the desktop at all (once the object is moved, its original, starting position is no longer displayed).

Similarly, instead of a transparency, the transient desktop object may be shown as an outline or footprint, or in solid view. The display may show a trail of echo images of the transient desktop object along its path as it is moved. It will be appreciated that still further options would be available for showing the starting and transient positions of an object, both in the screen map and on the desktop, such as for example depicting a starting or moving position by a symbol unrelated in shape to the object being moved.

In a further embodiment of the present invention, the transient screen map object and/or the transient desktop objects may be omitted, and the actual screen map object and/or the desktop object be moved as the user drags the cursor while on an object in the screen map. In such an embodiment, the actual position of the screen map and desktop objects would update (as described hereinafter) as the cursor moves the screen map object. It is further contemplated that the choice between the transient objects or having the actual objects move, and the appearance of the transient objects, may be selected by the user.

Referring again to step 1008, FIG. 10, if no mouse movement is detected, the application then checks in step 1016 whether the object has been released (i.e., whether the mouse button has been released). If not, return is made to step 1008 to continue to check for mouse movement. If the mouse has been released in step 1016, then the screen map object is displayed at the current cursor position (step 1018) and the transient screen map image is not displayed. Similarly, if the mouse is released, the desktop object is displayed at the current calculated position of the desktop object, and the transient desktop object is not displayed. For example, if the transient screen map and desktop objects are in the positions displayed in FIG. 11C when the mouse is released, the transient images disappear and the screen map object 406a and desktop object 406 will be displayed in their place as shown in FIG. 11D. After the display of the screen map and desktop objects at their new location, the application returns to step 502, FIG. 5.

FIGS. 11A-11D illustrate the example of the movement of window 406. It is understood that the other screen map objects 402a and 404a could similarly be dragged around within the screen map 420 to affect the movement of the corresponding objects 402 and 404 on the desktop. Any other movable objects appearing on the desktop 400 could similarly be moved using their corresponding screen map object. Screen map 420 itself may be moved around the desktop 400 using its corresponding object 420a in the screen map 420.

It is also contemplated that using some selection mechanism (such as for example holding down the CTRL key while selecting objects in the screen map), the user could select multiple objects within the screen map and move multiple objects on the desktop together at one time. There may be corresponding transient objects on both the desktop and screen map in such an embodiment.

In addition to the functionality of moving desktop objects around the desktop, the objects within the screen map 420 may operate to affect some of the functionality of the corresponding objects on the desktop. As discussed above, if an object in the screen map is selected with a right button event in step 908, FIG. 9, then the application performs the steps shown and described with respect to FIG. 13. As shown in FIG. 13, upon a right button event while the cursor is on a screen map object, a dropdown menu may be displayed at the screen map object in step 1302. The dropdown menu may display functionality associated with a right click/button up of the corresponding object on the desktop. For example, where the screen map object represents a window on the desktop (such as for example objects 404a and 406a), by right clicking on the screen map object, the user may be presented with a dropdown menu with the options to maximize, minimize, cut, copy or close the object. Alternatively, where the screen map object represents an icon on the desktop (such as for example objects 402a), the user may be presented with a dropdown menu with the options to open, print, cut or copy the object.

In step 1304, the application checks for a mouse click on a specific operation on the dropdown menu. In the event no mouse click on the menu has been received, then if a time out period has passed, or if the mouse is moved to another location, the application returns to step 502, FIG. 5. Otherwise the application returns to step 1304 to wait for a mouse click on a menu item. If a mouse click is received on a menu item in step 1304, then the operation associated with that menu item is performed on the corresponding object on the desktop in step 1310. The application then returns to step 502, FIG. 5.

It is further contemplated that the screen map window 420 have at least some of the functionality provided on a conventional desktop for affecting en masse the objects displayed on the desktop upon a right click while the cursor is positioned on the background wallpaper in the screen map. As discussed above, if a space between objects in the screen map is selected with a right button event in step 920, FIG. 9, then the application performs the steps shown and described with respect to FIG. 14. As shown in FIG. 14, upon a right click between screen map objects on the screen map, a dropdown menu may be displayed at the cursor location on the screen map at a step 1402. The dropdown menu may display functionality associated with a right click on the wallpaper on the desktop. For example, by right clicking at a space within screen map 420 not occupied by an object, a drop down menu may be provided giving the user the option to auto-arrange, tile or cascade desktop objects.

In step 1404, the application checks for a mouse click while the cursor is positioned on a specific operation on the dropdown menu. In the event no mouse click on the menu has been received, then if a time out period has passed, or if the mouse is moved to another location, the application returns to step 502, FIG. 5. Otherwise the application returns to step 1404 to wait for a mouse click on a menu item. If a mouse click is received on a menu item in step 1404, then the operation associated with that menu item is performed on the corresponding object(s) on the desktop in step 1410. The application then returns to step 502, FIG. 5.

In the embodiments of the drop down menu described with respect to FIGS. 13 and 14, the application ignores mouse down and mouse up events while the cursor is positioned on the dropdown menu, and only detects a mouse click event. It is understood that the application could monitor mouse down and mouse up events while the cursor is positioned on a dropdown menu in addition to or instead of a mouse click in alternative embodiments.

The object 420a in the screen map 420 may have a variety of appearances. While generally in the same proportional shape as the screen map 420, the interior of the object may either be filled in black or with another opaque color, it may be transparent to a degree, or it may just appear as an outline of the screen map window. Alternatively, it may contain a further miniaturized bitmap of the desktop.

In embodiments described above, the application performing the present invention takes a bitmap image of the desktop and displays it in a screen map window. Instead of taking a true bitmap, it is understood that other representations for the objects on the desktop may be provided in the screen map. For example, words, legends, symbols and other graphical images may be used in the screen map to represent the objects on the desktop. Additionally, while the screen map 420 has been described above as being formed from a bitmap, it is understood that other image formats can be used in screen map 420. Moreover, in embodiments described above, the screen map objects appear in the same spatial relationship in the screen map as the desktop objects do on the desktop. However, it is understood that the objects in the screen map need not occupy their same spatial relation in the screen map as the corresponding objects on the desktop in alternative embodiments.

As used herein, a display may be a computer monitor, but may be any of a variety of other displays, including LCDs, wall displays and 3D holographic projections which use 3D pointing devices. Other types of displays are contemplated.

The foregoing detailed description of the invention has been presented for purposes of illustration and description. It is not intended to be exhaustive or to limit the invention to the precise form disclosed. Many modifications and variations are possible in light of the above teaching. The described embodiments were chosen in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

I claim:

1. A method of arranging objects on a display, comprising the steps of:
(a) displaying a screen map of the display, the screen map including at least a first object representing at least a second object displayed on the display; and
(b) moving the at least first object in the screen map, said step of moving the at least first object in the screen map moving the at least second object on the display.

2. A method of arranging objects on a display as recited in claim 1, said step (a) comprising the steps of capturing an image of the display and displaying the display image on the display within a window sized to be smaller than the display.

3. A method of arranging objects on a display as recited in claim 2, the method further comprising the step of periodically repeating said step of capturing an image of the display.

4. A method of arranging objects on a display as recited in claim 1, wherein, in said step (b), a given movement of the at least one first object in the screen map results in a larger movement of the at least one second object on the display.

5. A method of arranging objects on a display as recited in claim 1, further comprising the step of moving the screen map around on the display.

6. A method of arranging objects on a display as recited in claim 1, further comprising the step changing the size of the screen map on the display.

7. A method of arranging objects on a display as recited in claim 6, said step of changing the size of the screen map including the step of changing an aspect ratio of the screen map, the at least one first object changing in size in the same aspect ratio as the screen map.

8. A method of arranging objects on a display as recited in claim 1, said step (b) comprising the steps of creating a transient image of the at least one first image and displaying the transient image of the at least one first image in the screen map.

9. A method of arranging objects on a display as recited in claim 1, said step (b) comprising the steps of creating a transient image of the at least one second image and displaying the transient image of the at least one second image on the display.

10. A method of arranging objects on a display as recited in claim 1, further comprising the step of performing an operation on the at least second object on the display through selection of the at least first object on the screen map, the operation including at least one of: 1) closing the at least second object, 2) copying the at least second object, 3) maximizing the at least second object on the display, 4) minimizing the at least second object on the display, and 5) launching an application associated with the object.

11. A method of arranging objects on a display with a user interface selection device, comprising the steps of:
(a) creating an interactive map of the display, the interactive map including at least one image of at least one object appearing on the display; and
(b) displaying the interactive map on the display, wherein selection and movement of the at least one image of the at least one object by the user interface selection device results in a corresponding movement of the object on the display.

12. A method of arranging objects on a display as recited in claim 11, said step (a) comprising the steps of capturing an image of the display using an application processing interface.

13. A method of arranging objects on a display as recited in claim 11, the method further comprising the step of periodically repeating said steps of creating an interactive map of the display and displaying the interactive map on the display.

14. A method of arranging objects on a display as recited in claim 11, wherein, in said step (b), selection and movement of the at least one image of the at least one object by the user interface selection device results in a corresponding larger movement of the object on the display.

15. A method of arranging objects on a display as recited in claim 11, further comprising the step changing the size of the screen map on the display.

16. A method of arranging objects on a display as recited in claim 11, further comprising the step of performing an operation on the at least second object on the display through selection of the at least first object on the screen map, the operation including at least one of: 1) closing the at least second object, 2) copying the at least second object, 3) maximizing the at least second object on the display, 4) minimizing the at least second object on the display, and 5) launching an application associated with the object.

17. A computer-readable medium having computer-executable instructions for programming a processor to perform a method, comprising the steps of:
(a) displaying a screen map of a desktop on a display, the screen map including at least a first object representing at least a second object displayed on the desktop; and
(b) moving the at least first object in the screen map, said step of moving the at least first object in the screen map moving the at least second object on the desktop.

18. A computer-readable medium having computer-executable instructions for programming a processor to perform a method as recited in claim 17, said step (a) comprising the steps of capturing an image of the desktop and displaying the desktop image on the desktop within a window sized to be smaller than the desktop.

19. A computer-readable medium having computer-executable instructions for programming a processor to perform a method as recited in claim 18, further comprising the step of performing an operation on the at least second object on the display through selection of the at least first object on the screen map, the operation including at least one of: 1) closing the at least second object, 2) copying the at least second object, 3) maximizing the at least second object on the display, 4) minimizing the at least second object on the display, and 5) launching an application associated with the object.

20. A computer-readable medium having computer-executable instructions for programming a processor to perform a method as recited in claim 17, wherein, in said step (b), a given movement of the at least one first object in the screen map results in a larger movement of the at least one second object on the desktop.
